(19) United States
(12) Patent Application Publication
(10) Pub. No.: US 2007/0105674 A1
(43) Pub. Date: May 10, 2007

(54) Pulley and nubbed belt for belt drives

(76) Inventor: Andreas Hogn, Waidhofen an der Ybbs (AT)

Correspondence Address: Dipl Ing Franz Buerscher, Dorf 78 A 3343 Hollenstein an der Ybbs, Hollenstein an der Ybbs, 3343, AT

(21) Appl. No.: 10/582,878

(22) PCT Filed: Dec. 10, 2004
(86) PCT No.: PCT/AT04/00431

§ 371 Date: Jun. 14, 2006

(30) Foreign Application Priority Data
Dec. 17, 2003 (AT) A 2037/2003

(51) Int. Cl. F16H 55/30; F16H 7/00

(52) U.S. Cl. 474/152; 474/149; 474/153

(57) ABSTRACT

A pulley (1, 5, 6, 7, 12) for belt drives with nubbed belts (2, 11, 20), having recesses (3, 9, 13) for engagement with the nubs (4, 10, 21, 22), disposed at the lateral edges of the circumferential surface of the pulley (1, 5, 6, 7, 12) and open toward the side. Two or more such pulleys (1, 5, 6, 7, 12) can be disposed on the same shaft (8) adjacent to one another. The recesses (13) can be half circular cylinders and the adjoining pulleys (12) can thus be rotated at an angle to one another so that two recesses facing one another receive one circular cylindrical nub (4, 10). The recesses (3, 9, 13) may be U-shaped when viewed from above. As nub, a nubbed belt (2, 11, 20) may have either flat circular cylinders (4, 10) or cylinders or cones having an elliptical base, an oval base, or a base following the U-shape, disposed in rows, and, if necessary, offset from one another by half a pitch as well as overlapping.

The invention relates to a pulley for nubbed belts in a positive-locking and self-guiding belt drive, the nubbed belts having on their contact surface projections formed as nubs, e.g., in the form of a disc or a truncated cone, in a recurring geometrical arrangement, and the surface of the pulley being formed with recesses in a corresponding arrangement meshing with the nubs, as well as to a nubbed belt.

Modern belt drives in drive systems mostly use the commonly known timing belts which on their contact surface are provided with a toothing also provided on the circumference of the pulley at both the drive end and the output end. Besides, also nubbed belt drives are known in which the contact surface is provided with nub-like projections in a recurring geometrical arrangement, which together with complementarily formed pulleys form a positive-locking self-guiding drive arrangement. DE 29823929 U1 describes such arrangement having the nubs in parallel rows perpendicularly or at an angle of e.g. 30° to 45° to the direction of travel. As in all belt drives, the transmission of higher torques requires a greater belt width and thus wider pulleys. For nubbed belts, the latter are fitted with recesses on the surface, which receive the nubs so that a transmission of power becomes possible. The production of pulleys for nubbed belts calls for tools such as molds for plastics or metal parts, provided with slide units which constitute the cores for the nub recesses in the contact surface of the nubbed pulleys. These cores must be retractable during removal. The effort in terms of production engineering required for such an embodiment is large.

It is the object of the invention to make the production of a pulley for nubbed belts of the above described type substantially simpler and more inexpensive. This is accomplished with a special arrangement and shape of the recesses in that all recesses are located at the lateral edges of the pulley and in an axial direction are open toward the side and that, if necessary, two or more such pulleys are disposed in a torsionally rigid manner adjacent to one another on the same shaft. A casting or injection mold for a pulley of this design merely requires two circular cylindrical halves (mold insert), each having one circular cylindrical recess of the diameter of the desired pulley. At the inner surface area of each mold half, the cores for the recesses of the pulley are formed as permanent projections (projecting wall portions) integrally with the mold half. A convenient embodiment provides for the recesses, viewed from above, being formed essentially U-shaped and the U-shaped recesses at least partially embracing the projections, especially the base circles of the disc-shaped or frustoconical nubs. The U-shape forms a lateral opening. Such recesses are disposed at both lateral edges, equally spaced from one another, and offset from one another by half an angular pitch. A nubbed belt running thereon has approximately disc-shaped or pill-shaped nubs that plunge into the U-shape and adjoin the semi-circular surface in the U-shape, in order to transmit the torque. Of course, instead of the usual pill shape, the nubs may also constitute the positive to the recesses and, viewed from above, be U-shaped themselves. With respect to demolding, it is convenient if the flanks of the recesses adjacent to the lateral openings of the U-shaped recesses run parallel or, starting from the opening, converge toward one another. In such case, opening the mold and removing the formed pulley will not be a problem. Several of such pulleys can be joined to form a roller for wider nubbed belts. In this case, one of the embodiments provides for each of the recesses having the complementary shape of a nub halved in the direction of travel and, viewed from above, being preferably formed in a semi-circular shape. Each of the individual nubbed pulleys is relatively narrow and has outwardly open semi-cylindrical (D-shaped) recesses only at the side of the edges. If another such pulley is adjoined laterally, then the recesses will be complemented into a shape complementary to the nubs, e.g., into an entire flat circular cylindrical recess. Such a pulley, as a part of an entire pulley assembly, can be produced easily and inexpensively as well as in a dimensionally accurate manner. It is also possible to use other center-symmetric nub shapes than e.g. hemispherical shapes.

As mentioned hereinabove, pulleys of any width can be assembled by arranging them adjacent to one another. For this purpose, it is advantageous if the bore for the rotating shaft has two grooves offset at an angle to one another for assembling of layer-like composite multiple-width pulleys having recesses offset at an angle, and if the shaft is formed with a rib serving as pusher dog. In order to put together a package from a plurality of identical, relatively narrow, individual pulleys, positive-locking connections for assembling of layer-like composite pulleys can be provided at the flat sides of each pulley.

Known nubbed pulleys are provided with nubs in the form of pills, that is, flat circular cylinders. These are very well suited for the pulleys formed according to the invention. In order to achieve an even better adaptation to the configuration of the recesses at the circumferential surface of the pulley and thus increase the transmissive performance of a belt drive, it is convenient if the nubs have the physical shape of a flat cylinder or flat cone on the base of an ellipse or an oval or a cuboid shape with an adjoining half circular cylinder, the front surface being formed convex or rounded, as necessary. Also these nubs may be disposed in rows next to one another as well with overlaps and offset from one another.

Embodiment examples of the subject-matter of the invention are shown in the drawings.

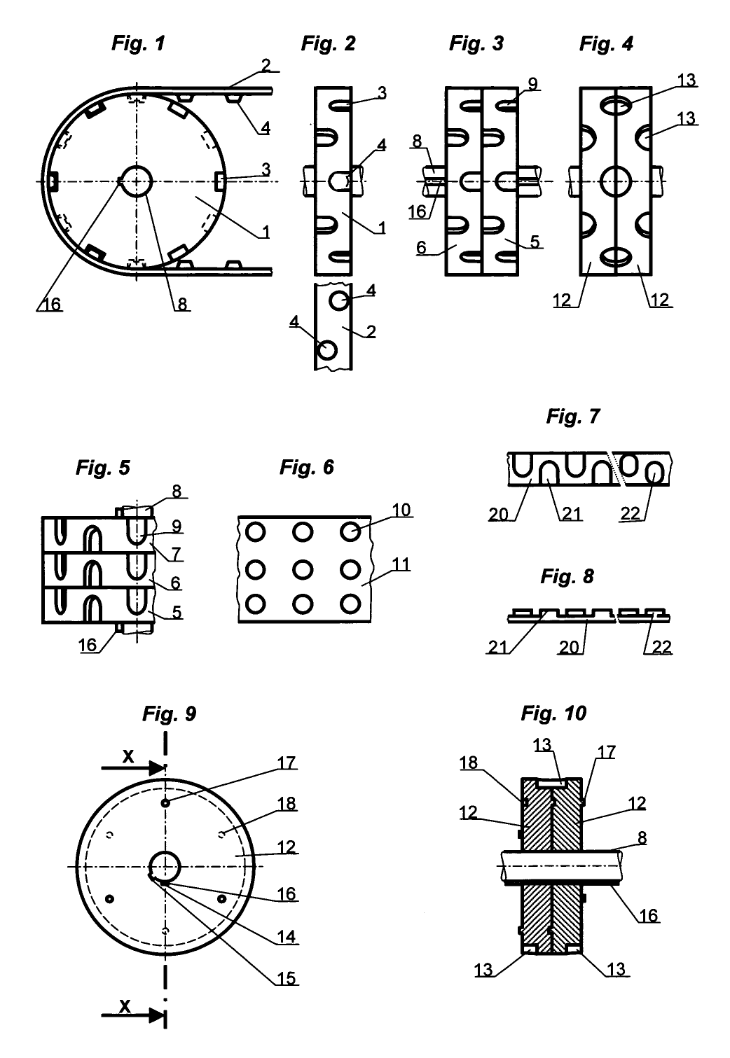

FIG. 1 shows the drive end of a belt drive with nubbed belt and pulley as a side view,

FIG. 2 shows a single pulley, viewed in the direction of travel of the nubbed belt,

FIG. 3 shows a variant of FIG. 2 having several pulleys on the same shaft,

FIG. 4 shows a view as in FIG. 3, however, with another design of the recesses for the nubs of the nubbed belt,

FIG. 5 shows a partial view of the pulleys of FIG. 1 as viewed from above,

FIG. 6 shows a partial view of a contact surface of a known nubbed belt,

FIG. 7 shows a partial view of the contact surface of a novel nubbed belt in a design for only one pulley,

FIG. 8 shows a side view of FIG. 7,

FIG. 9 shows a side view of a pulley on a shaft, and

FIG. 10 shows a cross-sectional view of FIG. 9 along line X-X of FIG. 9.

A pulley 1, as shown in FIGS. 1 and 2, for a belt drive with a nubbed belt 2 has recesses 3 at its circumference, which are not, as usual, formed for circular cylindrical (pill-shaped) nubs as complementary circular cylindrical indentations, but as slots whose width extends, according to the nub diameter, beyond the edge of the nubbed pulley 1 where they are open. These recesses 2 are alternatingly open at the left and right edges so that a nubbed belt 2, as adumbrated in FIG. 2, enters a positive-locking relationship with the pulley 1 so as to transmit a torque. Here, the nubs 4 of the nubbed belt 2 are alternatingly offset somewhat to the left and the right (approximately tangent to the edge), respectively.

The particular advantage of this embodiment of the pulley 1 resides in its production, as only a two-piece mold without movable cores is required because the recesses at the circumference extend all the way up to the edge.

FIG. 3 as well as FIGS. 5 and 6 show pulleys 5, 6, and 7 disposed torsionally rigid on a shaft 8. The recesses 9 again reach all the way up to the edge and are open toward the respective edge. In this embodiment, the nubs 10 of a suitably wide nubbed belt 11 are arranged in rows, one after the other and side by side, without lateral offset. Of course, it is possible to form a suitably wide pulley from the pulley 1 by joining identical pulleys to one another. The same applies to the narrow nubbed belt 2 which is available in any given width. FIG. 4 shows a distinctive feature. Similar to what is shown in FIG. 2, it shows pulleys 12 having recesses 13 with a semicircular outline. Again, only a two-piece mold is needed to produce the pulley 12. A single pulley 12 can already be used for the transmission of a torque, together with a nubbed belt provided with semicircular nubs overlapping with respect to the centerline of the nubbed belt.

If, as is shown in FIG. 4, several of such pulleys are disposed on one shaft 8 in order to transmit higher torques, then every second pulley 12 can be slid on the shaft as offset by a pitch angle—as is shown, for example, in FIG. 9. There, the pulley 12 has two grooves 14, 15 in the bore so that the pulley 12 can be slid onto a spring or rib 16 of the shaft 8 in three angular positions. In addition, positive-locking connections (e.g. three noses 17 and six indentations 18, respectively) are provided on the flat sides of the pulleys 12 facing one another. In a configuration of the mutual angular positions suitably tuned to the pitch angles of the recesses 13, two recesses 13 each immediately facing one another are complemented into a recess having a circular outline for a nub 4, as shown, for example, in the bottom portion of FIG. 2 on a narrow belt. What is also essential in this case is the advantage in terms of manufacturing technology, as has already been described hereinbefore.

To be able to fully utilize the recesses 3 and 9, respectively, shown in FIGS. 2, 3, and 5, as to their characteristics for the transmission of a torque, it is convenient as per FIGS. 7 and 8 to form a nubbed belt 20 with nubs 21 filling the recesses 3 and 9, respectively, to a greater extent, preferably entirely (that is, up to the edge). Here, the nubs 21 have the shape of half a flat circular cylinder, to whose diagonal a flat cuboid is adjoined, which reaches all the way up to the edge of the nubbed belt 20. Of course, the nubbed belt 20 may have a width corresponding to a multiple of the representation shown in FIG. 7.

In FIG. 7, a nub 22 is shown as a variant, which in its outline is formed as an oval or elliptically. The physical shape based thereon may correspond to a cylinder having parallel generatrices alongside the oval or the ellipse or to a cone having converging generatrices through the oval or the ellipse as base. Of course, also roundings and convex front surfaces of this physical shape are possible.

1. A pulley for nubbed belts in a positive-locking and self-guiding belt drive, the nubbed belts having on their contact surface projections formed as nubs, e.g., in the form of discs or truncated cones, in a recurring geometrical arrangement, and the surface of the pulley being formed with recesses in a corresponding arrangement meshing with the nubs, characterized in that all recesses (3, 9, 13) are disposed at the lateral edges of the pulley (1, 5, 6, 7, 12) and are open toward the side in an axial direction, and that, if necessary, two or more such pulleys (1, 5, 6, 7, 12) are disposed adjacent to one another in a torsionally rigid manner on the same shaft (8).

2. A pulley as claimed in claim 1, characterized in that the recesses (3, 9, 13), viewed from above, are formed essentially U-shaped, and that the U-shaped recesses at least partially embrace the projections, especially the base circles of the disc-shaped or frustoconical nubs (4, 10, 21, 22).

3. A pulley as claimed in claim 2, characterized in that both the recesses (3, 9, 13) and the nubs (21), viewed from above, are formed essentially U-shaped.

4. A pulley as claimed in claim 2, characterized in that the flanks of the recesses adjacent to the lateral openings of the U-shaped recesses (3, 9, 13) run parallel or, starting from the opening, converge toward one another.

5. A pulley as claimed in claim 1, characterized in that each of the recesses (13) has the complementary shape of a nub (10) halved in the direction of travel, and, viewed from above, is preferably of semicircular shape. (FIG. 4)

6. A pulley as claimed in one of claims 1 to 5, characterized in that the bore for the rotating shaft (8) has two grooves (14, 15) offset at an angle to one another for assembling of layer-like composite multiple-width pulleys (12) having recesses offset at an angle, and that the shaft (8) is formed with a rib (16) serving as pusher dog.

7. A pulley as claimed in one of claims 1 to 6, characterized in that at the flat sides of each pulley (12) positive-locking connections for assembling of layer-like composite pulleys (12) are provided (FIGS. 9, 10).

8. A nubbed belt for a pulley as claimed in one of claims 1 to 7, characterized in that the nubs (21, 22) have the physical shape of a flat cylinder or a flat cone on the base of an ellipse or an oval or a cuboid shape with an adjoining half circular cylinder, the front surfaces, being formed convex or rounded, as necessary. (FIGS. 7, 8)
